(19) United States
(12) Patent Application Publication
(10) Pub. No.: US 2026/0067163 A1
(43) Pub. Date: Mar. 5, 2026

(54) TECHNIQUES FOR DRIFT DETECTION IN A CLOUD COMPUTING ENVIRONMENT

(71) Applicant: Go Firefly Ltd., Tel Aviv (IL)

(72) Inventors: Sefi GENIS, Ramat Gan (IL); Ido NEEMAN, Tel Aviv (IL)

(73) Assignee: Go Firefly Ltd., Tel Aviv (IL)

(21) Appl. No.: 18/816,821

(22) Filed: Aug. 27, 2024

(51) Int. Cl. H04L 41/0869; H04L 41/0823

(52) U.S. Cl. CPC H04L 41/0869; H04L 41/0823

(57) ABSTRACT

A system and method for recovering resources of a cloud computing environment to a pre-drift configuration, is presented. The method includes generating a plurality of first code objects at a first time, each first code object generated based on configuration data of a resource of a plurality of resources deployed in a cloud computing environment; assigning to each code object of the first plurality of code objects a timestamp corresponding to the first time; detecting at a second time configuration data of the resource; detecting a configuration drift based on a comparison between a first code object, corresponding to the resource, and the configuration data detected at the second time; and generating a deployment plan of the resource to a pre-drift configuration in the cloud computing environment based on the first code object.

### TECHNICAL FIELD

The present disclosure relates generally to the field of disaster recovery, and more specifically to updating resource configurations based on drift detection in a cloud computing environment.

### BACKGROUND

Configuration drift in cloud computing occurs when the configuration of a system, such as a server or application environment, changes over time from its originally defined state. This can happen due to manual changes, updates, patches, or the deployment of new software.

Configuration drift is problematic for several reasons. It can lead to inconsistencies between different environments, such as development, testing, and production, making it difficult to ensure that software behaves the same way across these environments. This inconsistency can introduce bugs and errors that are hard to trace and resolve.

Moreover, configuration drift can weaken security by creating vulnerabilities that were not present in the original configuration. For instance, if security patches are not applied uniformly across all instances or if configuration changes inadvertently open up security holes, the system becomes more susceptible to attacks.

Additionally, it complicates maintenance and troubleshooting. When configurations are not standardized and drift from the intended state, it becomes challenging to replicate issues, perform updates, and manage the system effectively. This lack of standardization can lead to increased downtime and higher operational costs.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, method may include generating a plurality of first code objects at a first time, each first code object generated based on configuration data of a resource of a plurality of resources deployed in a cloud computing environment. Method may also include assigning to each code object of the first plurality of code objects a timestamp corresponding to the first time. Method may furthermore include detecting at a second time configuration data of the resource. Method may in addition include detecting a configuration drift based on a comparison between a first code object, corresponding to the resource, and the configuration data detected at the second time. Method may moreover include generating a deployment plan of the resource to a pre-drift configuration in the cloud computing environment based on the first code object. Other embodiments of this aspect include corresponding computer systems, apparatus, and computer programs recorded on one or more computer storage devices, each configured to perform the actions of the methods.

Implementations may include one or more of the following features. Method may include: querying an application programming interface (API) of the cloud computing environment to detect configuration data. Method may include: generating a code object for each unique resource of the plurality of resources. Method may include: encoding a plurality of resource values into the plurality of code objects, where each resource value indicates an associated resource configuration. Method may include: determining expected resource values that represent an expected resource configuration for a cloud computing environment. Method may include: comparing a resource value encoded in the an second code object with an expected resource value encoded in the first code object to detect the configuration drift. Method may include: triggering the deployment of resources to a pre-drift configuration by sending an instruction to an Infrastructure as Code (IaC) platform, where the instruction indicates that a configuration drift is detected. Method may include: detecting a configuration drift if a resource value from a code object differs from an expected resource value. Method may include: utilizing metadata to associate each code object with the timestamp. Method may include: generating a plurality of second code objects at the second time, each second code object generated based on configuration data of a resource of the plurality of resources; detecting the configuration drift based on a comparison between a first code object, and a second code object; and generating the deployment plan to the pre-drift configuration based on the first code object. Implementations of the described techniques may include hardware, a method or process, or a computer tangible medium.

In one general aspect, non-transitory computer-readable medium may include one or more instructions that, when executed by one or more processors of a device, cause the device to: generate a plurality of first code objects at a first time, each first code object generated based on configuration data of a resource of a plurality of resources deployed in a cloud computing environment, assign to each code object of the first plurality of code objects a timestamp corresponding to the first time, detect at a second time configuration data of the resource, detect a configuration drift based on a comparison between a first code object, corresponding to the resource, and the configuration data detected at the second time, and generate a deployment plan of the resource to a pre-drift configuration in the cloud computing environment based on the first code object. Other embodiments of this aspect include corresponding computer systems, apparatus, and computer programs recorded on one or more computer storage devices, each configured to perform the actions of the methods.

In one general aspect, system may include one or more processors configured to: generate a plurality of first code objects at a first time, each first code object generated based on configuration data of a resource of a plurality of resources deployed in a cloud computing environment. System may furthermore assign to each code object of the first plurality of code objects a timestamp corresponding to the first time. System may in addition detect at a second time configuration data of the resource. System may moreover detect a configuration drift based on a comparison between a first code object, corresponding to the resource, and the configuration data detected at the second time. System may also generate a deployment plan of the resource to a pre-drift configuration in the cloud computing environment based on the first code object. Other embodiments of this aspect include corresponding computer systems, apparatus, and computer programs recorded on one or more computer storage devices, each configured to perform the actions of the methods.

Implementations may include one or more of the following features. System where the one or more processors are further configured to: query an application programming interface (API) of the cloud computing environment to detect configuration data. System where the one or more processors are further configured to: generate a code object for each unique resource of the plurality of resources. System where the one or more processors are further configured to: encode a plurality of resource values into the plurality of code objects, where each resource value indicates an associated resource configuration. System where the one or more processors are further configured to: determine expected resource values that represent an expected resource configuration for a cloud computing environment. System where the one or more processors are further configured to: compare a resource value encoded in the an second code object with an expected resource value encoded in the first code object to detect the configuration drift. System where the one or more processors are further configured to: trigger the deployment of resources to a pre-drift configuration by sending an instruction to an Infrastructure as Code (IaC) platform, where the instruction indicates that a configuration drift is detected. System where the one or more processors are further configured to: detect a configuration drift if a resource value from a code object differs from an expected resource value. System where the one or more processors are further configured to: utilize metadata to associate each code object with the timestamp. System where the one or more processors are further configured to: generate a plurality of second code objects at the second time, each second code object generated based on configuration data of a resource of the plurality of resources; detect the configuration drift based on a comparison between a first code object, and a second code object; and generate the deployment plan to the pre-drift configuration based on the first code object. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example schematic diagram of a codifier in a cloud computing environment, implemented in accordance with an embodiment.

FIG. 2 is an example flowchart illustrating a method for generating a code object, implemented in accordance with an embodiment.

FIG. 3 is an example illustration of configuration properties of a detected resource, implemented in accordance with an embodiment.

FIG. 4 is an example illustration of a code object generated by the codifier, implemented in accordance with an embodiment.

FIG. 5 is an example flowchart for deploying resources based on declaration code in a cloud computing environment, implemented in accordance with an embodiment.

FIG. 6 is an example schematic diagram of a codifier generating code objects for drift detection, implemented in accordance with an embodiment.

FIG. 7 is an example flowchart for deploying pre-drift resource configurations in a cloud computing environment, implemented in accordance with an embodiment.

FIG. 8 is a schematic diagram of a codifier, implemented in accordance with an embodiment.

### DETAILED DESCRIPTION

The various disclosed embodiments include methods and systems for generate code objects based on detected configuration properties of deployed cloud resources in a cloud infrastructure. According to the disclosed embodiments, a code object is generated based on the detected configuration information of a unique resource deployed in a cloud computing environment.

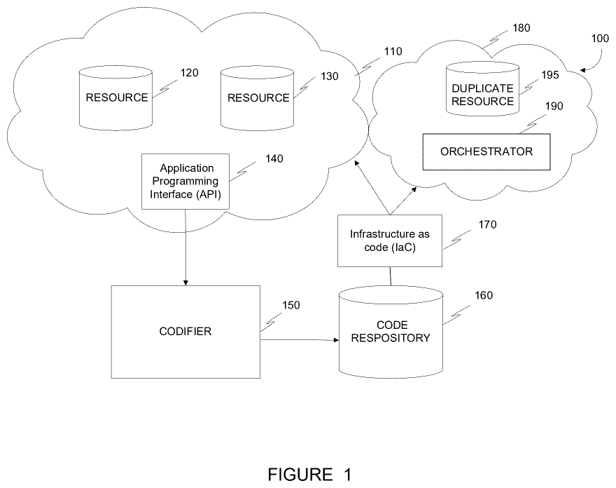

FIG. 1 is an example schematic diagram 100 of a codifier in a cloud computing environment, implemented in accordance with an embodiment. In an embodiment, the first cloud computing environment 110, includes a plurality of resources, such as a first resource 120, a second resource 130, and an Application Programming Interface (API) 140. In an embodiment, the first cloud computing environment 110 is communicative with a codifier 150, and an Infrastructure as Code (IaC) 170. In an embodiment, the codifier 150 is communicatively coupled with a code repository 160 and a second cloud computing environment 180. The second cloud computing environment 180 includes an orchestrator 190 and a single or a plurality of resources (e.g. a duplicate resource 195), in some embodiments.

In an embodiment, the first cloud computing environment 110 includes a virtual private cloud (VPC), Virtual Network (VNet), virtual private network (VPN) and the like. A cloud computing platform is implemented on a cloud computing infrastructure, for example, such as Amazon® Web Services (AWS), Google Cloud Platform® (GCP), Microsoft® Azure, and the like.

In an embodiment, the first cloud computing environment 110 includes a plurality of cloud entities deployed therein. According to an embodiment, a cloud entity is, for example, a principal, a resource, and the like. In an embodiment, a plurality of resources, such as a first resource 120, a second resource 130, a combination thereof, and the like, is deployed in the first cloud computing environment 110. In some embodiments, a first resource 120 and a second resource 130 are cloud entities that provide access to a compute resource, such as a processor, a memory, storage, and the like.

In some embodiments, a first resource 120 and a second resource 130, are virtual machines, software containers, serverless functions, and the like. According to certain embodiments, a first resource 120 and a second resource 130, include a software application deployed thereon, such as a webserver, a gateway, a load balancer, a web application firewall (WAF), an appliance, various combinations thereof, and the like.

In an embodiment, a cloud entity is a principal relative to another cloud entity and a first resource 120 to other cloud entities. In an embodiment, a cloud entity is a principal relative to another cloud entity and a second resource 130, to other cloud entities. For example, a load balancer is a first resource 120 to a user account requesting a webpage from a webserver behind the load balancer, and the load balancer is a principal to the webserver. In some embodiments, a first resource 120 and a second resource 130 are configured to communicate with each other via an internal bus, data bus, Local Area Network (LAN), inter-process communication (IPC), and the like.

In some embodiments, the first cloud computing environment 110 includes an Application Programming Interface (API) 140. In an embodiment, the API 140 is configured to enable two software components to communicate with each other using a set of definitions and protocols. In certain embodiments, the API 140 is utilized to access a first resource 120, a second resource 130, etc., of the first cloud computing environment 110. For example, in an embodiment, a first resource 120 is configured to generate an API call. In an embodiment, a process deployed on a virtual machine initiates an API call, for example to the API 140.

In an embodiment, the codifier 150 is configured to generate code objects. In some embodiments, the codifier 150 is configured to generate code objects based on configuration properties of detected resources. In an embodiment, the codifier 150 is configured to send requests, instructions, a combination thereof, and the like to the API 140 in a software language. For example, in an embodiment, the codifier 150 is configured to send a request to the API 140 requesting configuration information on deployed resources in the first cloud computing environment 110.

In certain embodiments, the API 140 is configured to convert the requests, commands, instructions, etc., from the codifier 150 into an internalized cloud system request. In various embodiments, the API 140 is configured to generate and return responses to the codifier's 150 requests, instructions, etc.

For example, in an embodiment, the API 140 is configured to send information on resources deployed in the first cloud computing environment 110 to the codifier 150 in response to the codifier 150 requesting information on the resources. For example, in an embodiment, the API 140 is configured to send information pertaining to deployed resources in the cloud computing environment, such as: resource identification, data source, Infrastructure as Code (IaC) status, a location of the resource, properties of the resource, tags of the resource, a timestamp, a combination thereof, and the like.

In some embodiments, the codifier 150 is configured to generate a code object, for example utilizing a language model. In an embodiment, the codifier 150 is configured to generate a prompt for a language model utilizing retrieved information from the API 140, a prompt template, a combination thereof, and the like, to generate a prompt for generating a code object.

In various embodiments, the codifier 150 is configured to provide the generated prompt to a single language model, a plurality of language models, and the like. In some embodiments, the language model is a large language model (LLM), small language model (SLM), and the like.

In an embodiment, the language model is configured to output a codifying prompt based on the input prompt from the codifier 150. In some embodiments, the codifier 150 is configured to feed the specific prompt to a single language model, a plurality of language models, etc., to generate a response. In an embodiment, the codifier 150 is configured to utilize data of the generated response from the language model to generate a code object.

In various embodiments, the code object is based on configuration properties of a deployed resource, a plurality of deployed resources, etc., in the first cloud computing environment 110.

In an embodiment, a code repository 160 includes a version control systems (VCS) repository that stores metadata for a set of files and stores the history of changes made to those files. For example, in an embodiment, the VCS is deployed utilizing Github®. In some embodiments, the code repository 160 is configured to store any one of: code objects, declaration code, IaC configuration files, Terraform® configuration file, a combination thereof and the like. In certain embodiments, the code repository 160 is a cloud database which is deployed to run in a public or hybrid cloud environment and is managed by database-as-a-service (DBaaS) or deployed in a cloud-based virtual machine (VM).

According to some embodiments, the VCS includes code objects of an IaC platform, such as IaC platform 170. In an embodiment, an IaC code object is, for example, a Terraform® code object.

An IaC platform 170 is configured to eliminate the need to manually configure and manage cloud resources, by defining the desired state of cloud resources using code, in various embodiments. Such code (e.g. declaration code) is typically written in a declarative language, allowing to specify the desired configuration and relationships between various resources, in an embodiment. In some embodiments, IaC code is version-controlled, shared, and collaborated on using code repository tools.

In some embodiments, the IaC platform 170 is configured to define and manage infrastructure resources across different cloud providers using code, offering a unified approach to infrastructure management in multi-cloud or hybrid cloud environments. Some examples of an IaC platform 170 used in the cloud computing industry include Terraform®, AWS® CloudFormation, Azure® Resource Manager, and Google® Cloud Deployment Manager. In various embodiments, an IaC platform 170 is configured to retrieve code objects from the code repository 160 and deploy them as instances in a second cloud computing environment 180.

In an embodiment, a second cloud computing environment 180 is implemented as a virtual private cloud (VPC), Virtual Network (VNet), virtual private network (VPN) and the like. A second cloud computing environment 180 is implemented on a cloud computing infrastructure, for example, such as Amazon® Web Services (AWS), Google Cloud Platform® (GCP), Microsoft® Azure, and the like. In an embodiment, the codifier 150 is configured to deploy a single or a plurality of resources in a second cloud computing environment 180. In some embodiments, the codifier 150 is configured to access code objects stored in the code repository 160. In various embodiments, the codifier 150 is configured to integrate the code objects with declaration code and incorporate them into a Terraform® configuration file, an IaC configuration file, a combination thereof, and the like. In various embodiments, such files (e.g. Terraform® configuration file, IaC configuration file) define the desired state and infrastructure of another cloud computing environment (e.g. second cloud computing environment 180) that is to be created.

Furthermore, such files (e.g. Terraform® configuration file, IaC configuration file) define resources that are to be deployed in another cloud computing environment (e.g. second cloud computing environment 180). In certain embodiments, code objects of the IaC configuration file (e.g. Terraform® configuration file) provide data that define resources, resource types, resource functions, resource locations, etc., a combination thereof and the like. In various embodiments, the codifier 150 is configured to trigger the deployment of a single or a plurality of resources in a second cloud computing environment 180.

In an embodiment, the codifier 150 is configured to trigger the deployment of a duplicate resource 195 of a plurality of resources in the second cloud computing environment 180. In certain embodiments, a duplicate resource 195 is identical resource located in the first cloud computing environment 110. In an embodiment, the duplicate resource 195 has an: identical resource type, identical resource function, identical resource deployment location, identical configuration, etc., a combination thereof, and the like, to a resource located in the first cloud computing environment 110.

In various embodiments, the codifier 150 is configured to send a request to the orchestrator 190 to provision the deployed resources. In various embodiments, the orchestrator 190 is configured to provision the deployed resources (e.g. duplicate resource 195) in the second cloud computing environment 180 by allocating any one of: a virtual machine, storage, networks, etc., a combination thereof and the like.

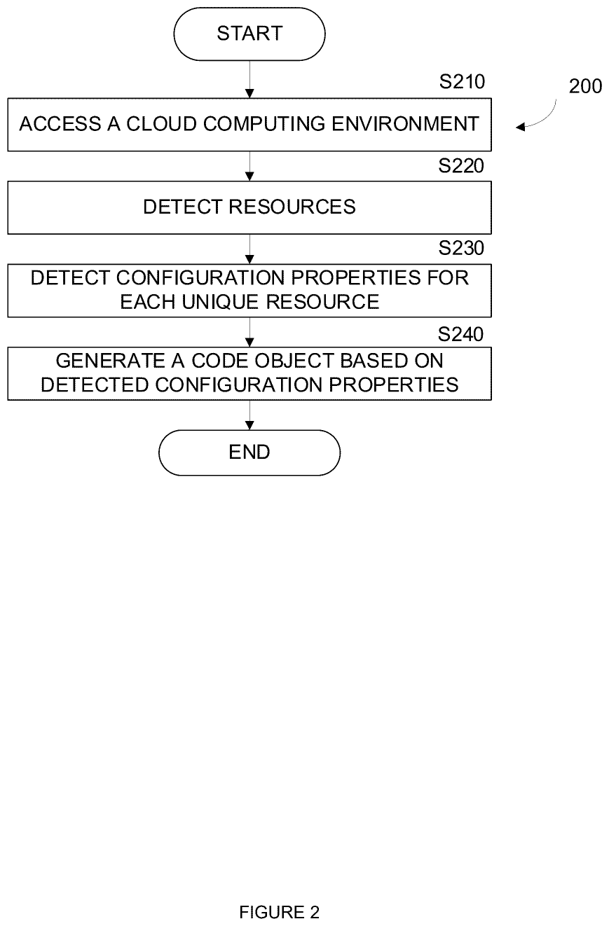

FIG. 2 is an example flowchart 200 illustrating a method for generating a code object, according to an embodiment.

At S210, a cloud computing environment is accessed. In an embodiment, a codifier (FIG. 1, 150) accesses a first cloud computing environment (FIG. 1, 110) including information about resources and configuration properties through an API (FIG. 1, 140). The codifier (FIG. 1, 150) is configured to obtain access to the first cloud computing environment (FIG. 1, 110) by sending requests (e.g. commands, instructions, etc.) to the API (FIG. 1, 140) seeking information about resources deployed in the first cloud computing environment (FIG. 1, 110).

At S220, resources are detected. In various embodiments, resources deployed in the first cloud computing environment (FIG. 1, 110) such as a first resource (FIG. 1, 120) and a second resource (FIG. 1, 130) are detected. The codifier (FIG. 1, 150) is configured to detect resources from the first cloud computing environment (FIG. 1, 110) by communicating with the API (FIG. 1, 140), according to an embodiment.

In an embodiment, the codifier (FIG. 1, 150) is configured to send requests (e.g. commands, instructions, etc.) to the API (FIG. 1, 140) seeking the identification of resources deployed in the first cloud computing environment (FIG. 1, 110). In certain embodiments, the API (FIG. 1, 140) is configured to convert the requests from the codifier (FIG. 1, 150) into a software language.

In an embodiment, the codifier (FIG. 1, 150) is configured to generate requests seeking configuration properties of deployed resources in the cloud computing environment (FIG. 1, 110). In various embodiments, the API (FIG. 1, 140) is configured to generate a response to a request from the codifier (FIG. 1, 150) including the identifying of resources deployed in the first cloud computing environment (FIG. 1, 110).

Further, in an embodiment, the API (FIG. 1, 140) is configured to generate responses to the codifier (FIG. 1, 150) identifying configuration properties of the deployed resources in the first cloud computing environment (FIG. 1, 110). In some embodiments, the codifier (FIGS. 1, 150) is configured to collect, extract, parse, etc., data from the received responses from the API (FIG. 1, 140) and identify configuration parameters of resources detected in the first cloud computing environment (FIG. 1, 110).

At S230, configuration properties for each unique resource is detected. In some embodiments, where the codifier (FIG. 1, 150) detects resources in the first cloud computing environment (FIG. 1, 110), then the codifier (FIG. 1, 150) is configured to request configuration information (e.g. configuration properties) for a unique resource.

In various embodiments, a unique resource is a detected resource which has multiple instances deployed in the computing environment. For example, in an embodiment, an Amazon® auto-scaling group (ASG) includes a plurality of virtual machines, each virtual machine being an instance from a single image, code object, etc.

In certain embodiments, the API (FIG. 1, 140) is configured to send a response providing further data about the unique resource such as an identification of the resource, data source, IaC status, location of the resource, configuration properties, tags, timestamp, a combination thereof, and the like. In some embodiments, the codifier (FIG. 1, 150) is configured to retrieve and parse the configuration information generated from the API (FIG. 1, 140) to detect configuration properties for each unique resource.

At S240, a code object is generated. In an embodiment, the code object is generated based on detected configuration properties. In some embodiments, the code object is generated based on detected configuration properties for each unique resource. In an embodiment, the codifier (FIG. 1, 150) is configured to generate code objects.

In various embodiments, the codifier (FIG. 1, 150) is configured to utilize the retrieved configuration information, stored prompt templates, and the like to generate a generic prompt. In an embodiment, the generic prompt is a request, command, query, instruction, a combination thereof, and the like. In some embodiments, the generic prompt is provided to a language model to generate a specific prompt.

In certain embodiments, the specific prompt is a request, command, query, instruction, a combination thereof, and the like. The codifier (FIG. 1, 150) is configured to provide the specific prompt to language model, in an embodiment. In certain embodiments, the language model is configured to generate a response to the specific prompt from the codifier (FIG. 1, 150).

In various embodiments, the codifier (FIG. 1, 150) is configured to retrieve the response from the language model and utilize the language model response to generate a code object. In some embodiments, the code object is generated based on the generic prompt, specific prompt, and configuration properties of resources deployed in the cloud computing environment (FIG. 1, 110), a combination thereof, and the like.

In an embodiment, the code object includes configuration code of a specific IaC platform, such as Terraform®. In certain embodiments, the configuration code includes a plurality of code objects, each code object corresponding to a resource deployed in the computing environment accessed by the codifier.

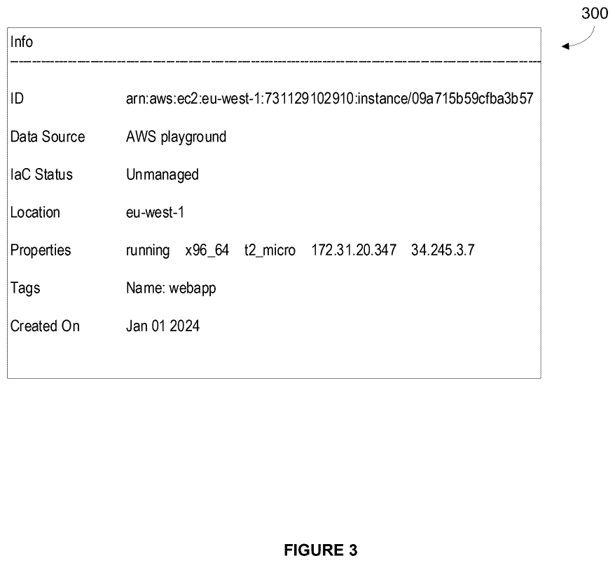

FIG. 3 is an example illustration 300 of configuration properties of a detected resource, implemented in accordance with an embodiment.

In some embodiments, the codifier (FIG. 1, 150) is configured to send requests, instructions, and the like, to the API (FIG. 1, 140) of a computing environment in order to receive configuration information pertaining to deployed resources in the cloud computing environment (FIG. 1, 110).

In various embodiments, the API (FIG. 1, 140) is configured to receive requests for configuration information for a unique resource from a codifier (FIG. 1, 150). In an embodiment the API is configured to convert a received request into internalized cloud system requests. Furthermore, the API (FIG. 1, 140) is configured to generate a response to the codifier's request for configuration information, in certain embodiments.

For example, in an embodiment, the API (FIG. 1, 140) is configured to provide the codifier (FIG. 1, 150) with configuration data of a unique resource such as a unique identifier of the resource 310, data source of the resource 320, IaC status of the resource 330, location of the resource 340, configuration properties 350, tags 360, a creation date of the resource 370, a combination thereof, and the like.

In an embodiment, deployed resources in a cloud computing environment 110 are assigned a unique identifier 310 which is used to track and manage the resource. In some embodiments, the unique identifier 310 is a string that includes a unique combination of letters and numerals. Further, in an embodiment, the unique identifier 310 indicates the type of resource, the zone the resource is located in, the region the resource is located in, a combination thereof, and the like.

In an embodiment, resources in a cloud computing environment have a data source 320 that indicates the initial location where the resource originated. In other embodiments, the data source 320 is a service or tool provided by the cloud infrastructure provider. For example, in some embodiments, the data source 320 is Amazon® Web Services (AWS) Management Console, Azure® portal, Google® Cloud Console, Google® Cloud API, and the like.

In some embodiments, resources in cloud computing environments include an IaC status 330. In various embodiments, an IaC platform (FIG. 1, 170) is configured to define and manage cloud computing resources across different cloud providers using code. An IaC platform (FIG. 1, 170) offers a unified approach to infrastructure management in multi-cloud or hybrid cloud environments. Various embodiments, of the IaC platform (FIG. 1, 170) used in the cloud computing industry include Terraform®, AWS® CloudFormation, Azure® Resource Manager, and Google® Cloud Deployment Manager.

In certain embodiments, an IaC status 330 indicates whether a resource in the cloud computing environment (FIG. 1, 110) is actively managed or controlled by an IaC platform (FIG. 1, 170).

In certain embodiments, the API (FIG. 1, 140) is configured to indicate locations 340 of resources in a cloud computing environment which indicate the location at which the resource is deployed.

In various embodiments, resources in a cloud infrastructure have configuration properties 350. In some embodiments, configuration properties 350 define the structure of a deployment including the type and properties of the resources that are deployed in the cloud infrastructure. For example, in some embodiments, configuration properties 350 include any one of: an instance type, a key pair, a security group, user data, Identity and Access Management (IAM) role, an availability zone, any combination thereof, and the like.

In some embodiments, tags 360 are used to assign metadata to resources in the cloud infrastructure. In various embodiments, tags 360 are tools used to manage, identify, organize, search for, and filter resources in the cloud infrastructure.

In various embodiments, resources in a cloud infrastructure have a creation date 370 which indicates the date the resource was created. In certain embodiments, the creation date 370 is a timestamp that indicates the time the resource was created. In an embodiment, the creation date is a date of deployment of the resource, a date of creation of a code object from which the resource is deployed, and the like.

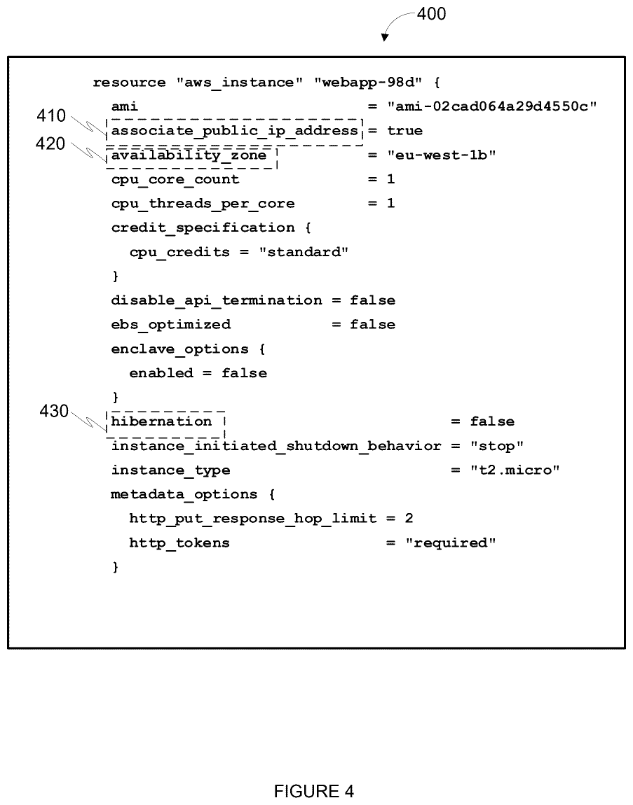

FIG. 4 is an example illustration of a code object 400 generated by the codifier, implemented in accordance with an embodiment.

Components of a cloud computing environment (FIG. 1, 110) are deployed, in an embodiment, utilizing an infrastructure as code platform, development tools, and the like, in a development (i.e., dev) environment, and deployed to a test environment where code is tested.

In various embodiments, a code object is a unit of code that can be deployed and run within a cloud infrastructure. The code object is generated by a codifier (FIG. 1, 150) based on configuration information of the deployed resources (e.g. unique resources) in the cloud infrastructure. For example, in an embodiment, code objects include configuration properties such as an internet protocol address 410, an availability zone 420, hibernation status 430, a combination thereof, and the like.

In an embodiment, the codifier (FIG. 1, 150) is configured to access the cloud computing environment (FIG. 1, 110) through the API (FIG. 1, 140). In some embodiments, the codifier (FIG. 1, 150) is configured to send requests, instructions, and the like, to the API (FIG. 1, 140) to detect configuration information pertaining to resources deployed in the cloud computing environment (FIG. 1, 110).

In an embodiment, the API (FIG. 1, 140) is configured to generate configuration information. In some embodiments the codifier (FIG. 1, 150) is configured to send a response to the codifier (FIG. 1, 150) identifying resources and providing configuration information about unique resources deployed in the cloud infrastructure. In some embodiments, the codifier (FIG. 1, 150) is configured to collect, extract, parse, etc., the generated response from the API (FIG. 1, 140).

In various embodiments, the codifier (FIG. 1, 150) is configured to utilize both the received configuration information response from the API (FIG. 1, 140) and a stored prompt template to generate a generic prompt.

In an embodiment, the generic prompt includes a request, command, query, instruction, a combination thereof, and the like. In some embodiments, the generic prompt is provided to an LLM to generate a specific prompt.

In certain embodiments, the specific prompt includes a request, command, query, instruction, a combination thereof, and the like. The codifier (FIG. 1, 150) is configured to provide the specific prompt to a language model, in an embodiment. In certain embodiments, the language model is configured to generate a response to the specific prompt from the codifier (FIG. 1, 150).

In various embodiments, the codifier (FIG. 1, 150) is configured to retrieve the response from the LLM and utilize the LLM response to generate a code object. In some embodiments, a code object is generated based on the generic prompt, specific prompt, configuration properties of unique resources deployed in the cloud computing environment (FIG. 1, 110), a combination thereof, and the like.

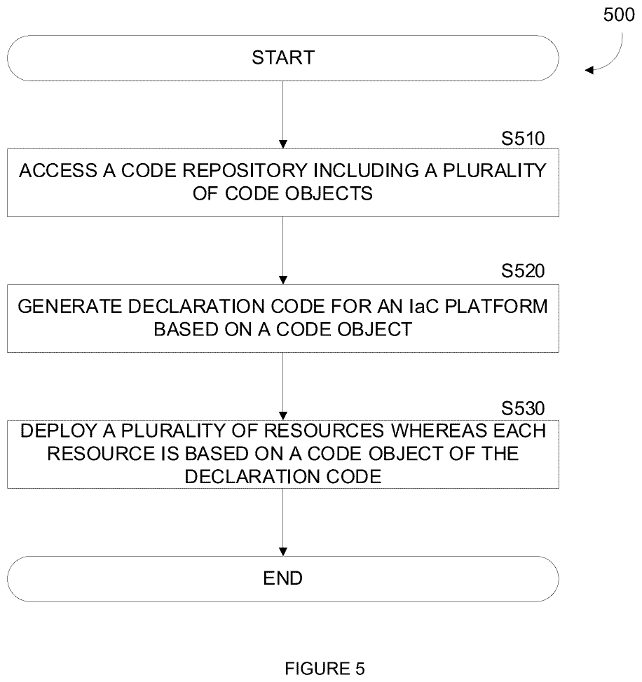

FIG. 5 in example flowchart 500 for deploying resources based on declaratory code in a cloud computing environment, implemented in accordance with an embodiment.

At S510, a code repository is accessed. In an embodiment, the code repository (FIG. 1, 160) including a plurality of code objects is accessed. In certain embodiments, a codifier (FIG. 1, 150) is configured to access the code repository (FIG. 1, 160) including code objects generated by the codifier (FIG. 1, 150) located in the code repository (FIG. 1, 160).

At S520, a declaration code is generated. In some embodiments, the declaration code is generated for an IaC platform. In an embodiment, the declaration code for the IaC platform (FIG. 1, 170) is generated based on a code object, a plurality of code objects, etc. In an embodiment, the codifier (FIG. 1, 150) is configured to generate declaration code based on the accessed code objects retrieved from the code repository (FIG. 1, 160).

In an embodiment, code objects from the code repository (FIG. 1, 160) are integrated into declaration code in an IaC configuration file, Terraform® configuration file, etc., a combination thereof, and the like.

In various embodiments, the Terraform® configuration file, the IaC configuration file a combination thereof, and the like, define the desired state of a cloud computing environment that is to be deployed. In an embodiment, the Terraform® configuration file, the IaC configuration file a combination thereof, and the like, define resources that are to be deployed in the cloud computing environment.

In some embodiments, the IaC configuration file (e.g. Terraform® configuration file) includes data on what types of resources should be deployed in the cloud computing environment including the function of each resource, the location of each resource within the cloud computing environment, a combination thereof, and the like.

In various embodiments, the codifier (FIG. 1, 150) is configured to send the generated declaration code located in the IaC configuration file (e.g. Terraform® configuration file) to the code repository (FIG. 1, 160) which stores the file. In some embodiments, the codifier is configured to provide access to an IaC platform to the declaration code.

At S530, a plurality of resources are deployed. In an embodiment, a plurality of resources are deployed wherein each resource is deployed based on a code object of the declaration code.

In some embodiments, the code objects that are integrated into the declaration code of the IaC configuration file (e.g. Terraform® configuration file) identify resources that should be deployed in a cloud computing environment. In certain embodiments, the code objects provide data that define resources, resource types, resource functions, resource locations in the cloud computing environment, a combination thereof, and the like. In various embodiments, the codifier (FIG. 1, 150) is configured to trigger the deployment a resource, a plurality of resources, and the like, in a second cloud computing environment (FIG. 1, 180).

In an embodiment, the codifier (FIG. 1, 150) is configured to trigger the deployment of a duplicate resource (FIG. 1, 195) in the second cloud computing environment (FIG. 1, 180). In certain embodiments, a duplicate resource (FIG. 1, 195) is deployed in the second cloud computing environment (FIG. 1, 180) and includes an identical configuration to a first resource located in the first cloud computing environment (FIG. 1, 110).

In an embodiment, the duplicate resource (FIG. 1, 195) includes an identical resource type, function, deployment location, combination thereof, and the like, of a resource in the first cloud computing environment (FIG. 1, 110). In an embodiment, the codifier (FIG. 1, 150), an IaC platform, and the like, is configured to send a request to an orchestrator (FIG. 1, 190) to provision the deployed resources. In various embodiments, the orchestrator (FIG. 1, 190) is configured to provision the deployed resources (e.g. duplicate resource FIG. 1, 195) in the second cloud computing environment (FIG. 1, 180).

According to an embodiment, the codifier is configured to trigger the deployment of a resource in a second cloud computing environment by providing the declaration code to an IaC platform, and initiating a computer instruction (for example through an API) which causes the IaC platform to deploy a resource in a second cloud computing environment based on the declaration code.

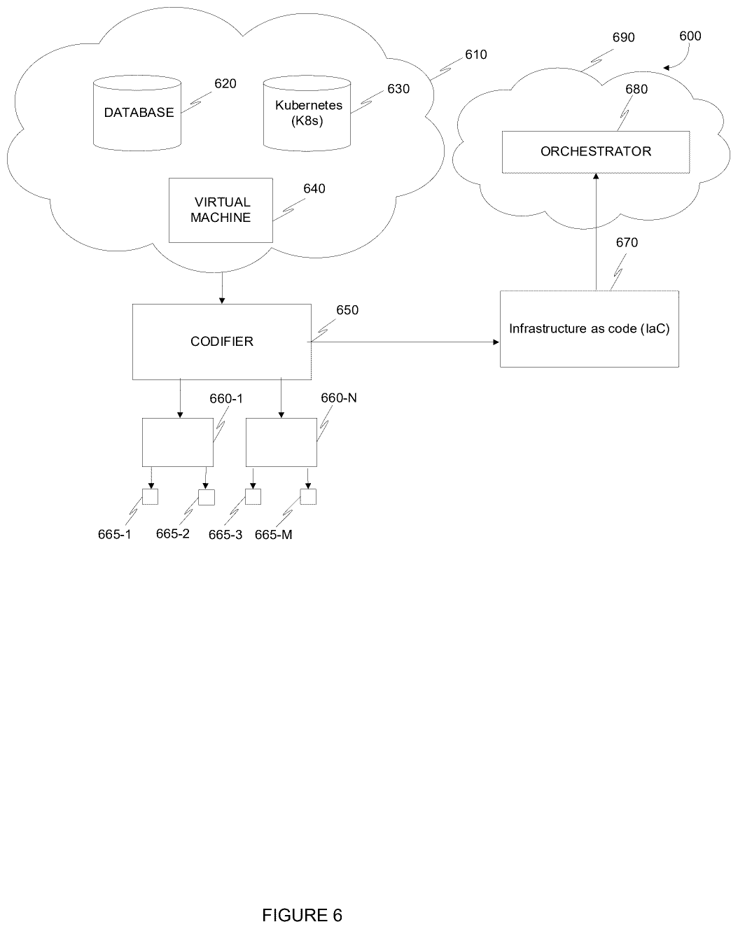

FIG. 6 is an example schematic diagram 600 of a codifier generating code objects for drift detection, implemented in accordance with an embodiment.

In an embodiment, the first cloud computing environment 610, includes a plurality of resources, such as a database 620, a software container 630 (e.g., implemented using a Kubernetes (K8s) cluster), a virtual machine 640, a combination thereof, and the like.

In an embodiment, the first cloud computing environment 610 is communicative with a codifier 650. In an embodiment, the codifier 650 is authorized to access an Infrastructure as Code (IaC) platform 670 and a second cloud computing environment 690.

In an embodiment, the second cloud computing environment 690 includes an orchestrator 680. In some embodiments, the second cloud computing environment 690 includes a resource, a plurality of resources, etc., such as a database, a virtual machine, a K8s cluster, a combination thereof, and the like.

In an embodiment, the first cloud computing environment 610 includes a virtual private cloud (VPC), Virtual Network (VNet), virtual private network (VPN) and the like. A cloud computing platform is implemented on a cloud computing infrastructure, for example, such as Amazon® Web Services (AWS), Google Cloud Platform® (GCP), Microsoft® Azure, and the like.

In certain embodiments, the database 620 is configured to run in a cloud computing environment, a hybrid cloud environment, as a managed database-as-a-service (DBaaS), deployed in a cloud-based virtual machine (VM), a combination thereof, and the like.

In various embodiments, a software container 630 includes a platform that is configured to automate operational tasks of container management. In certain embodiments, K8s is configured to automate the deployment, scaling, and operation of containerized applications.

In an embodiment, a virtual machine 640 is a compute resource that is configured to use software instead of a physical computer to run programs and deploy applications. According to some embodiments, a virtual machine 640 is, for example, Oracle® VirtualBox®, Microsoft Azure® Virtual Machines, Amazon® Elastic Compute Cloud, etc.

In various embodiments, the codifier 650 is configured to generate a plurality of snapshots 660-1 through 660-N (hereinafter referred to individually as a snapshot 660 and collectively as snapshots 660, merely for simplicity purposes). In an embodiment, the codifier 650 is configure to generate a code object, such as code objects 665-1 through 665-M, based on resources (e.g. database, Kubernetes, virtual machine, etc.) deployed in a cloud computing environment 610.

In some embodiments, the codifier 650 is configured to extract resource data, configuration data, etc., from deployed resources in the cloud computing environment 610. In various embodiments, resource data includes a resource name, an identifier of the resource, an owner of the resource, a resource name, a resource size, a virtual address of the resource, storage volume of the resource, a combination thereof, and the like.

In certain embodiments, the codifier 650 is configured to generate snapshots 660 of resource configuration, for example by grouping together a group of code objects generated at a specific point in time. In some embodiments, the codifier 650 is configured to generate snapshots 660 for different time periods. For example, in an embodiment, the snapshot 660-1 is generated at a first time, and the snapshot 660-N is generated at a second time, after the first time.

In an embodiment, code object 665-1 corresponds to the virtual machine 640 at a first time, and code object 665-3 corresponds to the virtual machine 640 at a second time. In some embodiments, the code object 665-1 is generated based on a different configuration data than the code object 665-3. This is known as configuration drift.

In some embodiments, the codifier 650 is configured to generate a plurality of code objects 665-1 through 665-M (hereinafter referred to individually as a code object 665 and collectively as code objects 665, merely for simplicity purposes). In an embodiment, the codifier 650 is configured to generate code objects 665 and assign each to a generated snapshot 660.

According to some embodiments, the codifier 650 is configured to associate each code object 650 with a timestamp. In some embodiments, the codifier 650 is configured to utilize metadata generated from a computing device to associate code objects with a timestamp. In some embodiments, the code object and the associated timestamp represent various resource status indications occurring at a specific point in time.

In some embodiments, the codifier 650 is configured to detect whether the resource configuration of a cloud computing environment 610 has drifted from its expected configuration. In various embodiments, the codifier 650 is configured to compare resource values encoded in code objects from different snapshots 660 with an expected resource values to determine whether configuration drift has been detected.

In some embodiments, the codifier 650 triggers the deployment of resources to a pre-drift configuration by sending an instruction to the IaC platform 670 confirming the detection of a configuration drift.

In an embodiment, the codifier 650 is configured to generate a declaratory code for execution by the IaC platform 670. In some embodiments, the codifier 650 is configured to generate the declaratory code based on code objects from a single snapshot, from a plurality of snapshots, etc. For example, in an embodiment, the codifier is configured to generate declaratory code based on code object 665-1 and code object 665-M, which each correspond to a different resource at a different point in time.

An IaC platform 670 is configured to eliminate the need to manually configure and manage resources in a cloud computing environment. In some embodiments, the IaC platform 670 is configured to define and manage infrastructure resources across different cloud providers using code, offering a unified approach to infrastructure management in multi-cloud or hybrid cloud environments. Some examples of an IaC platform 670 used in the cloud computing industry include Terraform®, AWS® CloudFormation, Azure® Resource Manager, and Google® Cloud Deployment Manager.

In various embodiments, the IaC platform 670 is configured to receive an input message, instruction, and the like, from the codifier 650 indicating the detection of a configuration drift. In response to the input message, the IaC platform 670 is configured to deploy resources in a pre-drift configuration in a cloud computing environment.

According to some embodiments, the IaC platform 670 is configured to send a request to the orchestrator 680 to provision the pre-drift configuration of resources in a cloud computing environment. In various embodiments, the orchestrator 680 provisions the pre-drift configuration of resources in a first cloud computing environment 610, which creates an identical cloud computing environment as cloud computing environment 610 in terms of resource configuration.

In certain embodiments, the orchestrator 680 is configured to deploy the pre-drift configuration of resources in a second cloud computing environment 690, which constitutes a cloud computing environment that the resources were not initially deployed in.

In an embodiment, a second cloud computing environment 690 is implemented as a virtual private cloud (VPC), Virtual Network (VNet), virtual private network (VPN) and the like. A second cloud computing environment 690 is implemented on a cloud computing infrastructure, for example, such as Amazon® Web Services (AWS), Google Cloud Platform® (GCP), Microsoft® Azure, and the like.

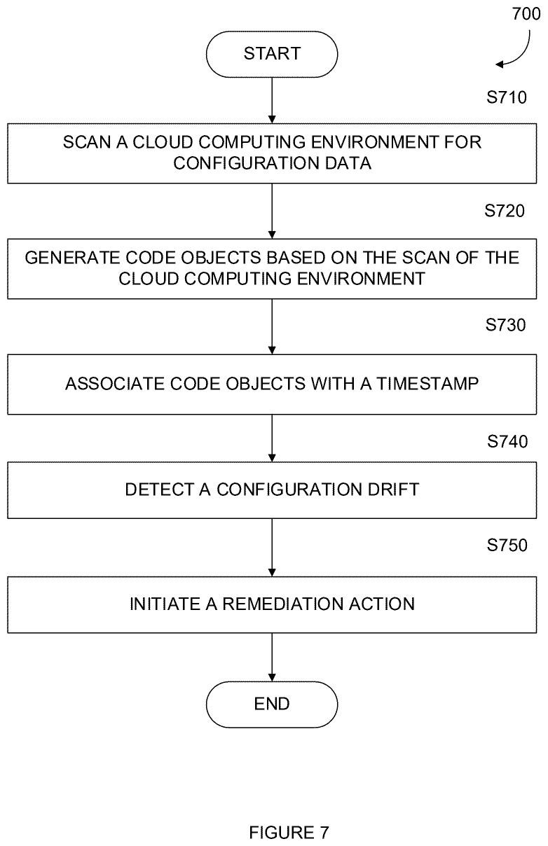

FIG. 7 is an example flowchart 700 for deploying pre-drift resource configurations in a cloud computing environment, implemented in accordance with an embodiment.

At S710, a computing environment is scanned. In an embodiment, the computing environment is a cloud computing environment. In some embodiments, scanning a cloud computing environment includes accessing an API of the cloud computing environment to detect resources deployed therein.

In some embodiments, configuration data is extracted by querying the API of the cloud computing environment. In an embodiment, the query includes a request for configuration data, for example based on an identifier of a resource deployed in the cloud computing environment.

At S720, code objects are generated. In an embodiment, code objects are generated based resource configuration data extracted from a scan of a cloud computing environment. In an embodiment, a codifier is configured to generate code objects for each unique resource.

In some embodiments, the codifier is configured to generate code objects based on resources, resource data, and any other resource information, a combination thereof, and the like. In an embodiment, resource data includes any one of: an identifier of the resource, an owner of the resource, a resource name, a resource size, a virtual address of the resource, storage volume of the resource, a combination thereof, and the like.

In certain embodiments, each generated code object corresponds to a specific resource. In some embodiments, each generated code object corresponds to a plurality of resources located in the cloud computing environment. For example, in an embodiment, a first code object is utilized to deploy each virtual machine of an auto-scaling group (ASG). According to some embodiments, the code objects are utilized in a declaratory code for an IaC platform.

At S730, a code object is associated with a timestamp. In various embodiments, each code object is associated with a timestamp. According to certain embodiments, the codifier is configured to associate each code object with a timestamp. In some embodiments, the codifier is configured to utilize metadata generated from a computing device to associate code objects 665 with a timestamp.

In some embodiments, the code object and the associated timestamp represent various resource status indications occurring at a specific point in time. In one embodiment, metadata includes information about resources and characteristics associated with the resources.

For example, in an embodiment, metadata includes any one of: information on the last time the resource was modified, creation time of the resource, the date the resource was created, the date the resource was deployed, the last time the resource was accessed, the geographic location of the resource, the amount of frequency of change to the resource, a combination thereof, and the like.

In some embodiments, a snapshot of resources is generated. In an embodiment, the codifier is configured to generate a snapshot based on generated code objects. In an embodiment, code objects are generated based on resources (e.g. database, software container, serverless function, virtual machine, etc.) deployed in a cloud computing environment.

According to various embodiments, a snapshot represents cloud computing environment configuration of a given point in time of a cloud computing environment. In an embodiment, a snapshot captures resource data, state of resources, status information of resources in a cloud computing environment, a combination thereof, and the like.

In certain embodiments, a snapshot is associated with a timestamp, such that each code object that is associated with the snapshot is associated with a single timestamp.

At S740, configuration drift is detected. In an embodiment, a code object from a first snapshot is compared to a corresponding code object from a second snapshot to detect a configuration drift. In an embodiment, the codifier is configured to detect whether the resource configuration in a cloud computing environment has drifted from its expected configuration (i.e., a previous configuration).

In certain embodiments, the codifier is configured to determine expected resource values which represent an expected resource configuration for a specific cloud computing environment, specific resource, a combination thereof, and the like. In an embodiment, an expected resource configuration is a cloud computing environment's initial resource configuration, a selected resource configuration based on a timestamp, etc.

In some embodiments, the codifier is configured to encode resource values into generated code objects. In an embodiment, resource values indicate an associated resource configuration of a specific resource. In some embodiments, the codifier is configured to compare resource values with expected resource values to detect a configuration drift. In some embodiments, if a resource value from a code object differs from an expected resource values then a configuration drift is detected.

For example, in an embodiment, a resource value of a code object from a first snapshot corresponding to a first time is compared to a resource value of a corresponding code object from a second snapshot corresponding to a second time. In this embodiment, the first snapshot and its resource values are utilized to determine the “expected” values, where values of the second snapshot are being compared to these expected values.

At S750, a remediation action is initiated. In an embodiment, a remediation action includes deploying resources to a pre-drift configuration, triggering deployment of the same, etc. In an embodiment, the codifier is configured to trigger the deployment of resources to a pre-drift configuration in a cloud computing environment when a configuration drift is detected.

In various embodiments, the codifier is configured to trigger the deployment of resources to a pre-drift configuration by sending an input message, instruction, and the like, to the IaC platform indicating that a configuration drift is detected. The IaC platform is configured to receive the input message from the codifier and deploy resources in a cloud computing environment based on its pre-drift configuration.

According to some embodiments, the IaC platform is configured to send a request to an orchestrator to provision the pre-drift configuration of resources in a cloud computing environment. In various embodiments, the orchestrator is configured to provision the pre-drift configuration of resources in the first cloud computing environment, which is the cloud computing environment that the resources were initially deployed in.

In certain embodiments, an orchestrator is configured to deploy the pre-drift configuration of resources in a second cloud computing environment, which is an environment that the resources were not initially deployed in.

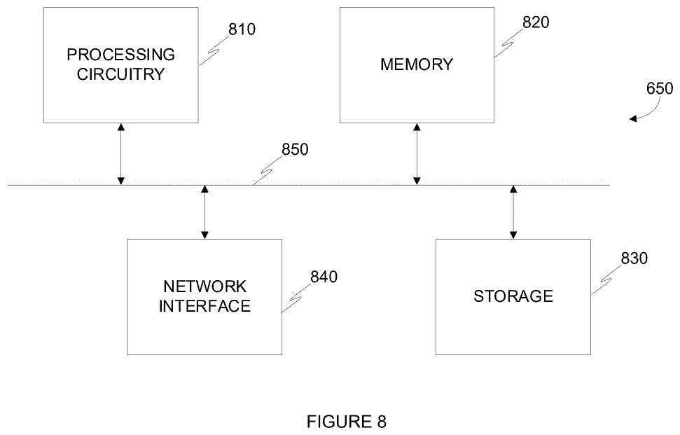

FIG. 8 is an example schematic diagram of a codifier 650 according to an embodiment. The codifier 650 includes a processing circuitry 850 coupled to a memory 820, a storage 830, and a network interface 840. In an embodiment, the components of the codifier 650 may be communicatively connected via a bus 850.

The processing circuitry 810 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 820 may be volatile (e.g., random access memory, etc.), non-volatile (e.g., a read-only memory, flash memory, etc.), or a combination thereof.

In one configuration, software for implementing one or more embodiments disclosed herein may be stored in the storage 830. In another configuration, the memory 620 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 810, cause the processing circuitry 810 to perform the various processes described herein.

The storage 830 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 840 allows the codifier 650 to communicate with, for example, the IaC 670, resources in the cloud computing environments, and the like.

It should be understood that the embodiments described herein are not limited to the specific architecture illustrated in FIG. 8, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for recovering resources of a cloud computing environment to a pre-drift configuration, comprising:
generating a plurality of first code objects at a first time, each first code object generated based on configuration data of a resource of a plurality of resources deployed in a cloud computing environment;
assigning to each code object of the first plurality of code objects a timestamp corresponding to the first time;
detecting at a second time configuration data of the resource;
detecting a configuration drift based on a comparison between a first code object, corresponding to the resource, and the configuration data detected at the second time; and
generating a deployment plan of the resource to a pre-drift configuration in the cloud computing environment based on the first code object.

2. The method of claim 1, further comprising:
querying an application programming interface (API) of the cloud computing environment to detect configuration data.

3. The method of claim 1, further comprising:
generating a code object for each unique resource of the plurality of resources.

4. The method of claim 1, further comprising:
encoding a plurality of resource values into the plurality of code objects, wherein each resource value indicates an associated resource configuration.

5. The method of claim 1, further comprising:
determining expected resource values that represent an expected resource configuration for a cloud computing environment.

6. The method of claim 5, further comprising:
comparing a resource value encoded in a second code object with an expected resource value encoded in the first code object to detect the configuration drift.

7. The method of claim 1, further comprising:
triggering the deployment of resources to a pre-drift configuration by sending an instruction to an Infrastructure as Code (IaC) platform, wherein the instruction indicates that a configuration drift is detected.

8. The method of claim 1, further comprising:
detecting a configuration drift if a resource value from a code object differs from an expected resource value.

9. The method of claim 1, further comprising:
utilizing metadata to associate each code object with the timestamp.

10. The method of claim 1, further comprising:
generating a plurality of second code objects at the second time, each second code object generated based on configuration data of a resource of the plurality of resources;
detecting the configuration drift based on a comparison between a first code object, and a second code object; and
generating the deployment plan to the pre-drift configuration based on the first code object.

11. A non-transitory computer-readable medium storing a set of instructions for recovering resources of a cloud computing environment to a pre-drift configuration, the set of instructions comprising:
one or more instructions that, when executed by one or more processors of a device, cause the device to:
generate a plurality of first code objects at a first time, each first code object generated based on configuration data of a resource of a plurality of resources deployed in a cloud computing environment;
assign to each code object of the first plurality of code objects a timestamp corresponding to the first time;
detect at a second time configuration data of the resource;
detect a configuration drift based on a comparison between a first code object, corresponding to the resource, and the configuration data detected at the second time; and
generate a deployment plan of the resource to a pre-drift configuration in the cloud computing environment based on the first code object.

12. A system for recovering resources of a cloud computing environment to a pre-drift configuration comprising:
one or more processors configured to:
generate a plurality of first code objects at a first time, each first code object generated based on configuration data of a resource of a plurality of resources deployed in a cloud computing environment;
assign to each code object of the first plurality of code objects a timestamp corresponding to the first time;
detect at a second time configuration data of the resource;
detect a configuration drift based on a comparison between a first code object, corresponding to the resource, and the configuration data detected at the second time; and
generate a deployment plan of the resource to a pre-drift configuration in the cloud computing environment based on the first code object.

13. The system of claim 12, wherein the one or more processors are further configured to:
query an application programming interface (API) of the cloud computing environment to detect configuration data.

14. The system of claim 12, wherein the one or more processors are further configured to:
generate a code object for each unique resource of the plurality of resources.

15. The system of claim 12, wherein the one or more processors are further configured to:
encode a plurality of resource values into the plurality of code objects, wherein each resource value indicates an associated resource configuration.

16. The system of claim 12, wherein the one or more processors are further configured to:
determine expected resource values that represent an expected resource configuration for a cloud computing environment.

17. The system of claim 16, wherein the one or more processors are further configured to:
compare a resource value encoded in a second code object with an expected resource value encoded in the first code object to detect the configuration drift.

18. The system of claim 12, wherein the one or more processors are further configured to:
trigger the deployment of resources to a pre-drift configuration by sending an instruction to an Infrastructure as Code (IaC) platform, wherein the instruction indicates that a configuration drift is detected.

19. The system of claim 12, wherein the one or more processors are further configured to:
detect a configuration drift if a resource value from a code object differs from an expected resource value.

20. The system of claim 12, wherein the one or more processors are further configured to:
utilize metadata to associate each code object with the timestamp.

21. The system of claim 12, wherein the one or more processors are further configured to:
generate a plurality of second code objects at the second time, each second code object generated based on configuration data of a resource of the plurality of resources;
detect the configuration drift based on a comparison between a first code object, and a second code object; and
generate the deployment plan to the pre-drift configuration based on the first code object.
